(19) United States
(12) Patent Application Publication
(10) Pub. No.: US 2001/0043390 A1
(43) Pub. Date: Nov. 22, 2001

(54) Polarization insensitive semiconductor optical amplifier

(75) Inventors: Jong-Ryeol Kim, Suwon-shi (KR); Jong-In Shim, Kunpo-shi (KR)

Correspondence Address: KLAUBER & JACKSON, 411 HACKENSACK AVENUE, HACKENSACK, NJ, 07601

(73) Assignee: SAMSUNG ELECTRONIC CO., LTD.

(21) Appl. No.: 09/803,486

(22) Filed: Mar. 9, 2001

(30) Foreign Application Priority Data
Mar. 10, 2000 (KR) 2000-11925

(51) Int. Cl. H01S 3/00

(52) U.S. Cl. 359/344

(57) ABSTRACT

Disclosed is a polarization insensitive semiconductor optical amplifier (SOA) in an optical amplifying element having a substrate and a multi-layer structure, crystal growth layer including an active layer formed on the substrate. In the inventive optical amplifier, the active layer is divided into first and second areas having different polarization modes. An electrode means independently applies currents to the first and second areas. Therefore, the polarization insensitive semiconductor optical amplifier is capable of separately controlling TE and TM polarization gains so as to approximately equalize the TE polarization gain to the TM polarization gain.

### CLAIM OF PRIORITY

This application claims priority to an application entitled “Polarization Insensitive Semiconductor Optical Amplifier,” filed in the Korean Industrial Property Office on Mar. 10, 2000 and there duly assigned Serial No. 2000-11925.

### BACKGROUND OF THE INVENTION

1. Field of the Invention

The present invention relates generally to a polarization insensitive semiconductor optical amplifier (PI-SOA), and in particular, to a polarization insensitive semiconductor optical amplifier having two strain areas and their associated independent electrodes.

2. Description of the Related Art

A polarization insensitive SOA is very useful to amplify an optical signal in an optical communication system. As an optical signal loses its polarization information during transmission mode along the fiber, there have been demands for a SOA capable of amplifying the optical signal that is insensitive to polarization. In addition, optical elements such as a wavelength converter and an optical switching element, which are indispensable to a wavelength division multiplexing (WDM) system, are typically manufactured using the polarization insensitive SOA. Therefore, there is high demand for a low-priced polarization insensitive SOA.

FIG. 1 is a cross-sectional view illustrating the structure of a conventional semiconductor optical amplifier (SOA). As illustrated in FIG. 1, the conventional SOA has a stacked structure of an n-InP cladding layer 1, a 1.3 μm wavelength InGaAsP waveguide layer 2, a 1.55 μm wavelength InGaAsP active layer 3, a 1.3 μm wavelength InGaAsP waveguide layer 4, and a p-InP cladding layer 5.

The conventional method of manufacturing the PI-SOA, as described in the preceding paragraphs, is inefficient in producing a good polarization insensitive SOA as it is very difficult to apply a crystal growth (or epitaxial growth) process in the conventional method. Basically, the conventional method can be classified into the following three methods. The first method involves in manufacturing a gainable active area so that the structure has a square cross-section. The second method uses a strain-compensated multiple quantum well (MQW) technique. For detailed information, see IEEE, P.T.L, 7, p473 (1995) and IEEE, Q.E., 30, p695 (1994). The third method applies the slight a tensile strain to a bulk active layer to increase the breadth of the active layer. For detailed information, see E.L., 33 p1083 (1997).

However, the above conventional methods have some disadvantages. The first method is required to finely adjust the width of the active layer by about 0.2 to 0.31 μm which is very difficult using an etching process. The second method requires to apply a very high strain of over ±1.5% to the active layer which makes it very difficult to grow a good crystal growth layer (or epitaxial layer) at very high strain level. The third method can be achieved using a very simple process. Yet, this method is required to adjust the amount of strain within about 0.01%. It is known that even though the amount of strain varies by just 0.01%, the polarization sensitivity varies by about 1 dB. Moreover, even if the width of a stripe formed using the mesa etching process varies by just 0.2 μm from a target value, it is impossible to acquire a stable single mode FFP (Far Field Pattern). Furthermore, when uniform growth is achieved by an MOCVD (Metal-Organic Chemical Vapor Deposition) or an MBE (Molecular Beam Epitaxy) crystal growth process, the strain generally varies by about 0.02 to 0.03%. Therefore, the third method also imposes a limitation on the crystal growth.

### SUMMARY OF THE INVENTION

It is, therefore, an object of the present invention to provide a polarization insensitive SOA capable of separately controlling the transverse electric (TE) and transverse magnetic (TM) polarization gains so as to approximately equalize the TE polarization gain to the TM polarization gain.

It is another object of the present invention to provide an easy-to-manufacture polarization insensitive SOA capable of independently controlling the TE and TM polarization gains.

To achieve the above and other objects, there is provided a polarization insensitive SOA as an optical amplifying element having a substrate and a multi-layer structure including an active layer, which is formed on the substrate. In this optical amplifier, the active layer is divided into first and second areas with different polarization modes. An electrode means are provided to apply currents to the first and second areas independently. Furthermore, the polarization insensitive SOA includes an insulating layer formed on the upper part of a boundary between the first and second areas for electrically insulating the crystal growth layer on the first area from the crystal growth layer on the second area.

Preferably, the electrode means comprises a common electrode formed on the back of the substrate; the first and second electrodes formed on upper parts which are associated with the first and second areas of the crystal growth layer, respectively, wherein the first and second electrodes are spaced apart from each other by a predetermined interval.

Preferably, the multi-layer structure comprises an upper waveguide layer formed on the active layer; an upper cladding layer formed on the upper waveguide layer; a lower cladding layer formed on the substrate; and, a lower waveguide layer formed on the lower cladding layer, wherein the lower waveguide layer is situated below the active layer.

Preferably, the first and second areas of the active layer are formed by a selective area growth (SAG) process. The first and second areas have different polarization modes depending on the currents applied thereto. Furthermore, the first and second areas have different band-gaps and strains.

Preferably, the first and second areas of the active layer are formed by separate growth processes and have a butt-joint structure.

### BRIEF DESCRIPTION OF THE DRAWINGS

The above and other objects, features, and advantages of the present invention will become more apparent from the following detailed description when taken in conjunction with the accompanying drawings in which:

FIG. 1 is a cross-sectional view illustrating a conventional polarization insensitive semiconductor optical amplifier;

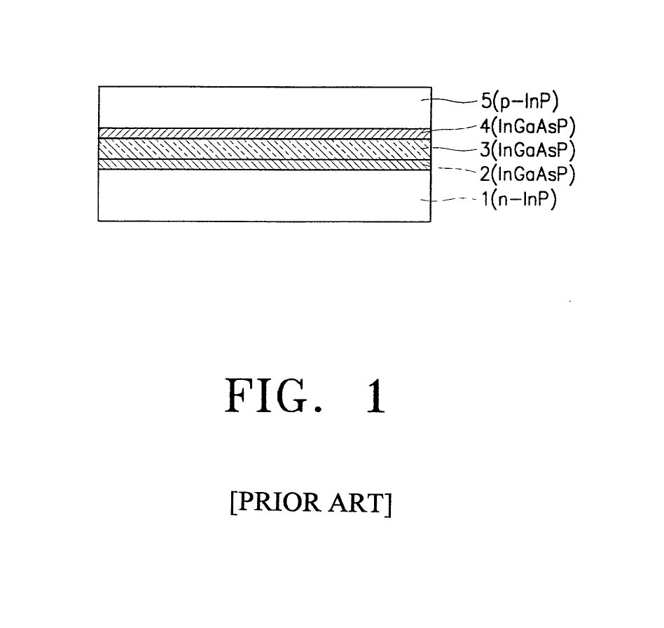

FIG. 2 is a cross-sectional view illustrating a polarization insensitive semiconductor optical amplifier according to a first embodiment of the present invention; and,

FIG. 3 is a cross-sectional view illustrating a polarization insensitive semiconductor optical amplifier according to a second embodiment of the present invention.

### DETAILED DESCRIPTION OF THE PREFERRED EMBODIMENTS

Preferred embodiments of the present invention will be described herein below with reference to the accompanying drawings. For the purpose of clarity, well-known functions or constructions are not described in detail as they would obscure the invention in unnecessary detail.

### First Embodiment

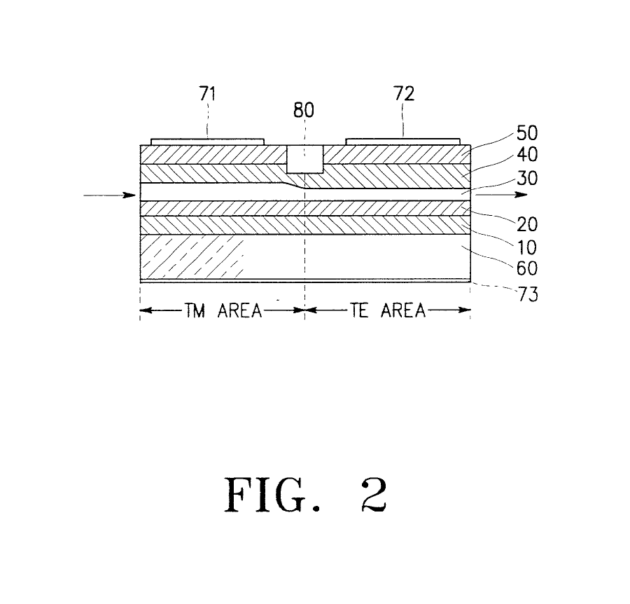

Referring to FIG. 2, the polarization insensitive SOA according to the first embodiment includes a common electrode 73 formed on the back of an n-InP substrate 60. On top of the n-InP substrate 60, an n-InP lower cladding layer 10, an InGaAsP lower waveguide layer 20, an InGaAsP active layer 30, an InGaAsP upper waveguide layer 40, and a p-InP upper cladding layer 50 are formed in succession. Accordingly, when current is injected into the SOA, the resulting electric field raises electrons in the SOA to excited states by emitting photons.

The active layer 30 is divided into a first area and second area through a selective area growth (SAG) process. The first and second areas have a transverse magnetic (TM) polarization mode and a transverse electric (TE) polarization mode, respectively. An insulating layer 80 is formed on the upper part and disposed as a boundary between the first and second areas of the active layer 30. First and second electrodes 71 and 72 associated with the first and second areas, respectively, are situated at both sides of the insulating layer 80. The first electrode 71 applies current to the first area, whereas the second electrode 72 applies current to the second area. Accordingly, the light beam incident upon the first area is amplified in the TM mode, while the light beam incident upon the second area is amplified in the TE mode.

Since the first and second areas are provided with independent currents through their respective first and second electrodes, the incident light beams are thus independently amplified in separate polarization modes.

The active layer 30, as mentioned above, is formed through the SAG process by applying a partial (or local) mask. For example, it is possible to form the active layer 30 divided into the first and second areas with different polarization modes by applying a mask having a narrower slot to the second area of the TE mode.

This embodiment is featured in that the active layer 30 is formed by the SAG process such that it has a dual strain, i.e., different strains or band-gaps at the first and second areas. For example, a band-gap difference and a strain difference between the first and second areas are 25 nm and 0.05%, respectively, but the second area has the longer wavelength and compressive strain. If the first area is so grown as to have the strain below −0.06%, the TM mode gain is higher in the first area. On the contrary, if the second area is so grown as to have the strain over 0.06%, the TE mode gain is higher in the second area. That is, it is possible to manufacture separate structures capable of acquiring the TM and TE mode gains on the same substrate using the SAG process. Accordingly, it is possible to easily manufacture the polarization insensitive SOA by properly adjusting the currents applied to the two areas.

### Second Embodiment

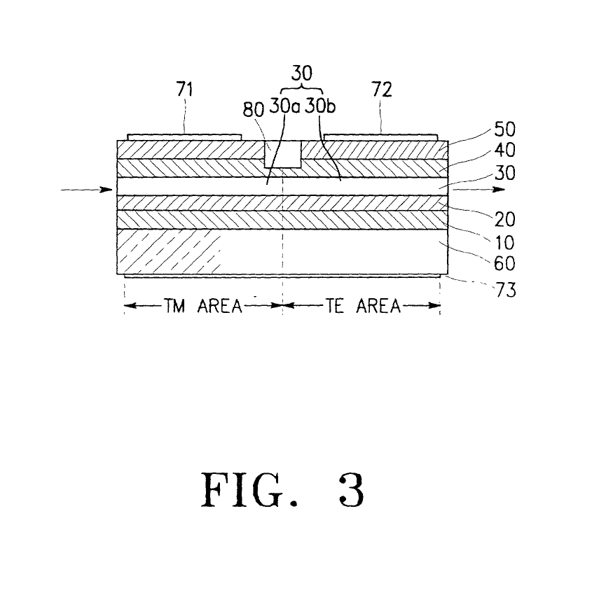

Referring to FIG. 3, the polarization insensitive SOA according to the first embodiment includes a common electrode 73 that is formed on the back of an n-InP substrate 60. On top of the n-InP substrate 60, an n-InP lower cladding layer 10, an InGaAsP lower waveguide layer 20, an InGaAsP active layer 30, an InGaAsP upper waveguide layer 40, and a p-InP upper cladding layer 50 are sequentially formed.

The active layer 30 is grown in two separate areas which are butt-jointed. That is, the first area 30a and the second area 30b are separately grown. Specifically, the first area 30a is grown as to obtain the TE mode gain by applying a tensile strain, whereas the second area 30b is grown as to obtain the TM mode gain by applying a compressive strain.

This embodiment is featured in that the active layer is formed to have the butt-joint structure with the separately grown first and second areas 30a and 30b, so that the active layer has a dual strain for providing the TE mode and the TM mode. As a matter of course, the first and second areas 30a and 30b are grown as to have different strains and different band-gaps. For example, in the first embodiment, a band-gap difference and a strain difference between the first and second areas 30a and 30b are 25 nm and 0.05%, respectively, but the first area 30a has the longer wavelength and compressive strain. If, for example, the second area 30b has the strain below −0.06%, the TM mode gain is higher in the second area. On the contrary, if the first area 30a has the strain over −0.06%, the TE mode gain is higher in the first area.

As it can be appreciated from the forgoing description, the novel polarization insensitive SOA for use in the next generation optical communication system can separately amplify the incident light beams regardless of their polarization states. In particular, the strains of the respective mode areas are adjusted within a certain range. Therefore, it is possible to adjust the gains of the respective modes by controlling the currents applied to the electrodes connected to the respective areas. Accordingly, it is possible to approximately equalize the gains of the respective modes by electrically adjusting the amplifications of the respective modes. In particular, when the polarization sensitivities of the respective areas deviate within a predetermined value (i.e., 1 dB), which inevitably occurs during the growth of the respective areas, it is possible to adjust the polarization sensitivities of the respective areas by finely adjusting the currents applied to the areas through their associated electrodes. As a result, the polarization insensitive SOA can have a wide operating wavelength band. Furthermore, the process variation among the elements can be externally adjusted, contributing to a remarkable increase in the yield.

While the invention has been shown and described with reference to a certain preferred embodiment thereof, it will be understood by those skilled in the art that various changes in form and details may be made therein without departing from the spirit and the scope of the invention as defined by the appended claims.

What is claimed is:

1. A polarization insensitive semiconductor optical amplifier (SOA) in an optical amplifying element having a substrate and a multi-layer structure including an active layer formed on the substrate, the optical amplifier comprising:
said active layer divided into first and second areas having different polarization modes; and,
an electrode means for independently applying currents to the first and second areas.

2. The optical amplifier as claimed in claim 1, further comprising an insulating layer formed as a boundary between the first and second areas for electrically insulating a crystal growth layer on the first area from a crystal growth layer on the second area.

3. The optical amplifier as claimed in claim 1, wherein the electrode means comprises:
a common electrode formed on the back of the substrate; and,
first and second electrodes formed on the upper parts associated with the respective first and second areas of the crystal growth layer, the first and second electrodes being spaced apart from each other by a predetermined interval.

4. The optical amplifier as claimed in claim 1, wherein the multi-layer structure comprises:
an upper waveguide layer formed on the active layer;
an upper cladding layer formed on the upper waveguide layer;
a lower cladding layer formed on the substrate; and,
a lower waveguide layer formed on the lower cladding layer, the lower waveguide layer being situated below the active layer.

5. The optical amplifier as claimed in claim 3, wherein the multi-layer structure comprises:
an upper waveguide layer formed on the active layer;
an upper cladding layer formed on the upper waveguide layer;
a lower cladding layer formed on the substrate; and,
a lower waveguide layer formed on the lower cladding layer, the lower waveguide layer being situated below the active layer.

6. The optical amplifier as claimed in claim 1, wherein the first and second areas of the active layer are formed by a selective area growth (SAG) process.

7. The optical amplifier as claimed in claim 2, wherein the first and second areas of the active layer are formed by a selective area growth (SAG) process.

8. The optical amplifier as claimed in claim 5, wherein the first and second areas of the active layer are formed by a selective area growth (SAG) process.

9. The optical amplifier as claimed in claim 3, wherein the first and second areas of the active layer are formed by a selective area growth (SAG) process.

10. The optical amplifier as claimed in claim 4, wherein the first and second areas of the active layer are formed by a selective area growth (SAG) process.

11. The optical amplifier as claimed in claim 1, wherein the first and second areas of the active layer are formed by separate growth processes and formed by a butt-joint structure.

12. The optical amplifier as claimed in claim 2, wherein the first and second areas of the active layer are formed by separate growth processes and formed by a butt-joint structure.

13. The optical amplifier as claimed in claim 5, wherein the first and second areas of the active layer are formed by separate growth processes and formed by a butt-joint structure.

14. The optical amplifier as claimed in claim 3, wherein the first and second areas of the active layer are formed by separate growth processes and formed by a butt-joint structure.

15. The optical amplifier as claimed in claim 4, wherein the first and second areas of the active layer are formed by separate growth processes and formed by a butt-joint structure.
